(19) United States
(12) Patent Application Publication
(10) Pub. No.: US 2009/0213342 A1
(43) Pub. Date: Aug. 27, 2009

(54) PROJECTION EXPOSURE APPARATUS FOR MICROLITHOGRAPHY

(75) Inventors: Hans-Joachim Weippert, Aalen (DE); Karl-Heinz Schuster, Koenigsbronn (DE)

Correspondence Address: FISH & RICHARDSON PC, P.O. BOX 1022, MINNEAPOLIS, MN, 55440-1022, US

(73) Assignee: Carl Zeiss SMT AG, Oberkochen (DE)

(21) Appl. No.: 11/577,531

(22) PCT Filed: Oct. 20, 2005
(86) PCT No.: PCT/EP2005/055422

§ 371 Date: Apr. 29, 2009

Related U.S. Application Data
(63) Continuation of application No. 60/632,550, filed on Dec. 1, 2004.

(30) Foreign Application Priority Data
Oct. 22, 2004 (DE) 10 2004 051 730.4

(51) Int. Cl. G03B 27/52; G03B 27/54

(52) U.S. Cl. 355/30; 355/67

(57) ABSTRACT

The invention relates to a projection exposure apparatus with a projection objective that serves to project a structure onto a substrate coated with a light-sensitive resist, wherein an immersion liquid is arranged between an optical element of the projection objective and the resist-coated substrate. As an immersion liquid saturated cyclic or polycyclic hydrocarbons can be used, such as for example cyclo-alkanes comprising up to 12 carbon atoms, saturated polycyclic hydrocarbons with 2 to 6 rings, bridged polycyclic hydrocarbons, cyclic ethers and derivatives of these substances.

This Application claims benefit of U.S. Provisional Application No. 60/632,550 filed Dec. 1, 2004.

The invention relates to a projection exposure apparatus with a projection objective that serves to project a structure onto a substrate coated with a light-sensitive resist, wherein an immersion liquid is arranged between an optical element of the projection objective and the coated substrate.

The invention further relates to the use of substances as immersion liquids in projection exposure apparatus of this kind.

Projection exposure apparatus in the field of microlithography are used for the production of semiconductor components and other finely structured components. In addition to a light source and an illumination system for illuminating a photo mask or a plate with a line pattern, often called a reticle, a projection exposure apparatus of this kind includes a projection objective which serves to project an image of the reticle onto a light-sensitive substrate, for example onto a silicon wafer that is coated with a photosensitive resist. Structures from which to produce an image can also include micro-mirror arrays or LCD arrays.

Until now, three concepts have been pursued to generate structures of ever smaller dimensions reaching an order of magnitude of less than 100 nm: First, there is an attempt to continuously increase the numerical aperture NA of the projection objective. Second, the wavelength of light used for the illumination, the so-called operating wavelength, is continuously reduced, preferably to wavelengths shorter than 250 nm, for example 248 nm, 193 nm, 157 nm, or even less. Finally, yet further measures are used to improve the resolution, such as phase-shifting masks, dipole illumination, or oblique illumination.

Another concept for increasing the resolving power is based on the idea of bringing an immersion medium, in particular an immersion liquid, into the interstitial space that remains between a last lens on the image side of the projection objective and the photo-sensitive resist or another light-sensitive layer that is to be exposed. This technique is referred to as immersion lithography. Projection objectives that are designed to be operated with immersion are therefore also called immersion objectives.

As a result of introducing an immersion liquid one obtains an effective wavelength λ_{eff}=λ₀/n₁, wherein λ₀ represents the vacuum wavelength of the illuminating light and n₁ represents the refractive index of the immersion liquid at the wavelength used for illumination. From the effective wavelength, one obtains a resolution R=k₁(λ_{eff}/NA₀) and a depth of focus (DOF) DOF=±k₂(λ_{eff}/NA₀_{²}), wherein NA₀=sin α₀ represents the “dry” numerical aperture and α₀ represents one-half of the aperture angle of the objective. The empirical constants k₁ and k₂ are process-dependent; among other factors, they depend on the illumination mode being used, in particular on the coherence parameter σ, or also on the properties of the resist.

The advantages of immersion lithography are therefore due to the fact that with the higher refractive index of the immersion liquid relative to vacuum, the illumination wavelength is reduced to an effective illumination wavelength. According to the correlations presented in the preceding paragraph, this goes together with an increase in resolution and in the depth of focus.

In the article “Immersion lithography at 157 nm” by M. Switkes and M. Rothschild, J. Vac. Sci. Technol. B 19(6), November/December 2001, pages 1 ff, immersion liquids based on perfluoro polyethers (PFPE) are presented, which are sufficiently transparent for an operating wavelength of 157 nm and are compatible with several of the photoresist materials that are currently used in microlithography. However, the refractive indices of these substances at wavelengths between 250 nm and 157 nm are no higher than a value of 1.38.

A projection exposure apparatus with an immersion liquid between the last optical element and a resist-coated light-sensitive substrate has been disclosed in U.S. Pat. No. 4,346,164. The immersion liquids named therein include primarily substances with aromatic ring systems, some of which are pure hydrocarbons such as benzene, dimethylnaphthylene, and ethylnaphthylene. Other substances among those named are halogen derivatives of benzene or of naphthalene or dimethylaniline. Another compound named as a suitable immersion liquid is phenylethylamine. However, aromatic substances and amines as a rule exhibit a strong absorption in the deep ultraviolet range. Thus, the low transmission of these substances for wavelengths of less than 260 nm precludes them from being used, or makes them at least very difficult to use, as an immersion liquid.

For an illumination wavelength of 193 nm, water of the highest purity is known to be usable as an immersion liquid. It has a sufficient transmission for the 248 nm as well as 193 nm wavelengths. However, it has been found that water of the highest purity can attack the optical surfaces of the objective that are in contact with the water. Furthermore, water has a relatively low refractive index of n₂₄₈≈1.378 at an operating wavelength of 248 nm and of n₁₉₃≈1.437 at 193 nm.

The objective of the invention is to propose a projection exposure apparatus with a projection objective which at illumination wavelengths of 248 nm and 193 nm offers in combination with the highest possible transmission a high resolution and depth of field as well as a high numerical aperture on the image side.

A solution meeting this objective is offered in a projection exposure apparatus according to the independent claims 1, 29, 49, 50, 53, 54 and 55.

Advantageous further embodiments of the invention are defined by the features of the dependent claims.

It is a further objective of the invention to name substances which are suitable for projection exposure apparatus with an operating wavelength of less than 250 nm, preferably less than 248 nm or 193 nm, and which at these wavelengths have as high a transmission as possible and a suitable refractive index to achieve a high resolution and depth of field.

The latter objective is met through the use of an immersion liquid in accordance with independent claims 58, 83 and 86. Advantageous further developed embodiments of the invention are defined by the features of the dependent claims.

Through the use of an immersion medium, in particular an immersion liquid, with a refractive index equal to or larger than the refractive index of an optical element of the projection objective, the resolution of an immersion objective can be pushed to the point where the resolutions achieved are so high that a dry objective could equal them only with the help of extremely shorter wavelengths (e.g., 126 nm) and an extremely high numerical aperture in air (e.g., NA=0.95). Also in comparison to immersion objectives with an immersion liquid of a significantly lower refractive index such as for example Water, one can achieve comparable or higher resolutions in this way, with a markedly lower NA₀=sin α₀. Accordingly, it becomes possible to choose less cumbersome designed optical projection systems. By keeping the 193 nm operating wavelength, one can do without expensive optical projection systems with optical elements made of crystal materials, and more cost-effective laser light sources can be considered.

In order to minimize losses due to total reflection at high angles of incidence at the boundary surface between the immersion liquid and the light-sensitive resist, it is advantageous if the refractive index of the immersion liquid is smaller than the refractive index of the resist.

It is further of significance in immersion objectives to use an immersion liquid which has an adequate transmission for light of the operating wavelength. This leads to a high performance/cost ratio of the projection exposure apparatus and accordingly a high degree of operating economy. With an operating distance of for example 3 mm, it is particularly advantageous at a operating wavelength of 248 nm, if the transmission reaches 70%, preferably 80%, and with special preference 90% or more. This correlates, respectively, to an extinction coefficient of the immersion liquid of 1.19 cm⁻¹, preferably 0.74 cm⁻¹, and with special preference 0.35 cm⁻¹ or less, consistent with the correlation ln(I/I₀)=−ε·d, i.e. Lambert-Beer's law, wherein I₀ represents the intensity of the incident radiation, d represents the distance traveled in the immersion liquid, I represents the intensity after traversing the distance d, and ε represents the extinction coefficient. The foregoing extinction coefficients as well as all extinction coefficients stated hereinafter in the description and the claims are based on the foregoing correlation using the natural logarithm. A different formulation of Lambert-Beer's law, which is more commonly used in the field of chemistry, uses the decimal logarithm, log(I/I₀)=−ε·d·log(e). The product α=ε·log(e) is referred to as decimal-based extinction coefficient. Thus, by multiplying the extinction coefficients stated above and hereinafter with the factor log(e)=0.434, they can easily be converted into the more customary form of decimal-based extinction coefficients.

At an operating wavelength of 193 nm, the selection of materials with a sufficiently high transmission is already significantly restricted. This applies to the selection of suitable lens materials as well as immersion liquids. In order to be assured of a sufficiently high refractive index, it will in some cases be necessary to accept a relatively low transmission. At a wavelength of 193 nm and an operating distance of 1 mm between the optical element of the immersion objective and the light-sensitive substrate, a transmission above 70% is considered advantageous, corresponding to an extinction coefficient of less than 35.6 cm⁻¹. In immersion liquids with a relatively strong absorption, it is advantageous to select the operating distance so as to achieve a transmission of at least 70%, preferably 80%, and with special preference 90%.

In the operation of the objective, it is of advantage to channel the immersion liquid in a circuit, because this keeps the required amount of liquid relatively small, and very little waste occurs that needs to be disposed. However, contamination of the immersion liquid can occur during operation, for example by substances contained in the resist material, through a partial decomposition of the immersion liquid due to the exposure to UV radiation, or due to the small degree of solubility of materials that are in contact with the immersion liquid, such as lenses, mounts, liquid conduits. As a rule, these contaminations lead to an increased loss of light. It is therefore advantageous if the immersion liquid channeled through the circuit is regenerated by means of a regenerating device. It is particularly advantageous if the regenerating device is a part of the liquid circuit. It is further advantageous to monitor and adjust the condition of the immersion liquid continuously in regard to its physical and chemical properties.

In order to prevent the immersion liquid from entering into reactions under UV radiation in the presence of air oxygen, it is of advantage to operate the apparatus under a protective gas atmosphere such as for example N₂ or noble gases such as for example Argon.

As a regenerating device, one may consider for example a distillation apparatus or a chromatography apparatus. In comparison to simple filters, an apparatus of this kind has the advantage that it removes not only solid particles from the immersion liquid, but that dissolved chemical substances can also be separated from the actual immersion liquid. Thus, a very high degree of purity can be achieved which, in turn, ensures optimal transmission properties of the immersion liquid.

The inventors have recognized that while the state-of-the-art immersion liquids such as for example benzene, dimethylnaphthylene and ethylnaphthylene, halogen derivatives of benzene or of naphthalene, or dimethylaniline have suitable refractive indices for light with a wavelength below 250 nm, they do not have a sufficient transmission. This applies to a high degree to chemical compounds with aromatic ring systems. Due to their de-localized electrons, such compounds typically have a high absorption for wavelengths in the range below 300 nm. This also similarly applies to non-aromatic substances that contain double bonds. Double bonds have a significant degree of absorption in the range of wavelengths from 260 to 300 nm and also prove to be poorly suited in the range of wavelengths below 240 nm. The same is often true for chemical compounds with groups containing free electron pairs such as for example primary or secondary amines, organic compounds such as chlorine, bromine or iodine, as well as sulfur-containing compounds. Furthermore, when irradiated with UV light, compounds containing chlorine, bromine or iodine show a tendency towards photochemical reactions, particularly at wavelengths below 250 nm. With amines, there is the risk that reactions with the resist may occur, particularly under the influence of light.

The inventors have further recognized that cyclic or polycyclic hydrocarbons, in contrast to the above, not only have suitable refractive indices at a wavelength of 248 nm, but also exhibit very favorable transmission properties. Surprisingly, it has further been found that a great many of these substances also have an adequate transmission for light of 193 nm wavelength. At the same time, they are chemically inert towards the resist and even under the influence of light will not enter into chemical reactions with the resist nor with other materials that are in contact with the immersion liquid in a projection lithography apparatus. Furthermore, these compounds also are not subject to chemical breakup under UV radiation of the relevant wavelengths. The cyclic or polycyclic hydrocarbons have the special advantage of also being chemically inert towards the materials that can be considered for optical elements of the projection objective, i.e. for example quartz glass or calcium fluoride. Thus, one can get by without a complicated protective coating system for a lens element that is in contact with the immersion liquid. The surface tension of the cyclic or polycyclic hydrocarbons is notably smaller than the surface tension of water. The surface tension of water against air is 72 mN/m, while decalin, for example, has a surface tension of 24 mN/m. A low surface tension has a favorable effect on the wetting behavior of the immersion liquid against the optical element that it is in contact with and against the light-sensitive substrate. Many cyclic and polycyclic hydrocarbons are standardized commercially available products, or they can at least be produced at a justifiable cost.

Among the saturated cyclic hydrocarbons, the cyclo-alkanes and cyclo-alkane derivatives have suitable refractive indices combined with an adequate transmission. Their refractive indices are markedly higher than the respective refractive indices of the corresponding non-cyclic alkanes with equal numbers of carbon atoms. Also in stepping up in the series of homologs towards higher numbers of carbon atoms, the refractive index for cyclic alkanes increases faster than for non-cyclic alkanes.

Preferably those cyclic or polycyclic hydrocarbons should be used in a projection exposure apparatus for immersion lithography, which are liquid at its operating temperature. It is even more advantageous, if the melting point of the immersion liquid is low enough so that it has a sufficiently low viscosity at room temperature. However, even such cyclic or polycyclic hydrocarbons which have a high viscosity or which are solid at room temperature can be used, when the projection exposure apparatus is operated at elevated temperatures.

Especially preferred are cyclo-alkanes whose ring is formed by six carbon atoms, and with particular preference by more than seven carbon atoms. Derivatives of cyclo-alkanes with the molecular formula CₖR¹ . . . R^{2k} fall likewise within the range that is under consideration here, wherein k stands for the number of carbon atoms of the ring and R¹ to R^{2k} are selected, respectively, from the group that consists of —H, —CₙH₂ₙ₊₁, —OH and —CₙH₂ₙOH, wherein n represents a positive integer between 1 and 12.

The use of cyclohexane is particularly preferred because of its high transmission and refractive index as well as its availability. In addition, cyclohexane has a relatively low boiling point, which is of great advantage for the further processing of the exposed substrate, as the residues of cyclo-hexane can be completely removed from the substrate surface with only a slight heating or blow-cleaning, for example with nitrogen. A low boiling point is also advantageous for performing a regeneration, for example a distillation, of the immersion liquid that is being used.

It is also advantageous to use derivatives of cyclohexane with the molecular formula C₆R¹R²R³R⁴R⁵R⁶R⁷R⁸R⁹R¹⁰R¹¹R¹², wherein R¹ to R¹² are selected, respectively, from the group that consists of —H, —CₙH₂ₙ₊₁, —OH and —CₙH₂ₙOH, wherein n represents a positive integer between 1 and 12. With an appropriate selection of the side chain, it is possible to influence such properties as boiling point, viscosity and solvent behavior in a controlled manner. However, substituting the hydrogen atoms with groups R has only a minor influence on properties such as refractive index or transmission.

While cyclo-alkanes with more than seven carbon atoms have higher boiling points than cyclohexane, they are also less easily flammable. Cyclooctane, like cyclohexane, is easily available commercially and exhibits outstanding properties in regard to its refractive index and transmission. Derivatives of cyclooctane with the molecular formula C₈R¹R²R³R⁴R⁵R⁶R⁷R⁸R⁹R¹⁰R¹¹R¹²R¹³R¹⁴R¹⁵R¹⁶, wherein R¹ to R¹⁶ are selected, respectively, from the group that consists of —H, —CₙH₂ₙ₊₁, —OH und —CₙH₂ₙOH, where n represents a positive integer from 1 to 12, can be influenced in some of their properties through specific selection of the respective side chains, in an analogous manner as described above for cyclohexane.

Apart from cyclohexane and cyclooctane, further cyclo-alkanes like cycloheptane (7 carbon atoms), cyclononane (9 carbon atoms), cyclodecane (10 carbon atoms), cycloundecane (11 carbon atoms) or cyclododecane (12 carbon atoms) and their derivatives, having side chains R selected from the group that consists of —H, —CₙH₂ₙ₊₁, —OH and —CₙH₂ₙOH, wherein n represents a positive integer between 1 and 12, as described before, can be used.

As mentioned above, several physical properties of the cyclo-alkanes can be influenced by proper selection of groups R, for example with respect to the number of carbon atoms n in such a side chain. It is advantageous to choose the number of carbon atoms n in such a way, that the derivative of a cyclic or polycyclic hydrocarbon is still liquid at the operating temperature and that its viscosity is suitable for use in an immersion projection objective. In this context, it is particularly advantageous to choose n between 1 and 10, even more advantageous between 1 and 7 and extraordinary advantageous between 1 and 5. However, even if the viscosity is high or if the melting point of the hydrocarbon is higher than the operating temperature, it still can be used as an immersion liquid, when the projection exposure apparatus is operated at an elevated temperature.

The inventors have recognized that the refractive index increases not only with the increase of the number of atoms in an individual carbon ring, but that the refractive index also increases with the number of rings, sometimes referred to as nuclei, in a polycyclic saturated hydrocarbon. Polycyclic saturated hydrocarbons that fall under consideration here are compounds that can be produced by complete catalytic hydration from polycyclic aromatic compounds with 2 to 6 rings. Suitable compounds include in particular decahydronaphthalene (decalin), perhydrofluorene, perhydroindene, perhydrophenanthrene, perhydrobenzopyrene, perhydroanthrazene, perhydrofluoranthene, perhydroindenopyrene, perhydrobenzofluoranthene, perhydrochrysene, perhydrotetraphenylene, perhydropentalene, perhydroazulene, perhydroheptalene, perhydrobiphenylene, perhydroindazene, perhydroacenaphthylene, perhydrophenalene, perhydropyrene, perhydronaphthazene, and perhydrocoronene.

It has been found in experiments with these substances that their transmission properties as well as the value of their index of refraction depend on the proportion of unsaturated bonds which remain after the catalytic hydration. It was found to be particularly favorable if the proportion of remaining unsaturated bonds is smaller than 50 ppm, preferably smaller than 5 ppm, and with particular preference smaller than 1 ppm.

As in the aforementioned cycloalkanes, properties such as the melting point or the viscosity can also be influenced in the polynucleic polycyclic saturated hydrocarbons by adding side chains R, without influencing the refractive index or the transmission too strongly. Preferably, side chains R are selected from the group —H, —CₙH₂ₙ₊₁, —OH and CₙH₂ₙOH, wherein n represents a positive integer between 1 and 12. It is advantageous to choose the number of carbon atoms n in such a way, that the resulting derivative of a polycyclic alkane is liquid at the operating temperature and that its viscosity is suitable for use in an immersion projection apparatus. In this context, it is particularly advantageous to choose n between 1 and 10, even more advantageous between 1 and 7 and extraordinary advantageous between 1 and 5.

Further preferred polycyclic saturated compounds are bridged polycyclic hydrocarbons such as for example norbornane, adamantane, tricyclodecane, or bicyclo [3.3.2]decane.

In several of the aforementioned polycyclic hydrocarbons, geometric isomerism occurs, which is also referred to as stereo-isomerism. While all of the atoms of isomeric molecules have the same bond partners, their spatial arrangement is different. This is the case for example in cis- and trans-decahydronaphthalene. The different stereo-isomeres possess slightly different physical properties. Thus, the refractive index of cis-decahydronaphthalene is different from trans-decahydronaphthalene. By way of the ratio of components of the isomeric forms in a mixture it is therefore possible to vary the refractive index of the immersion liquid.

The range of immersion liquids to be considered further includes compounds with cyclic ether structures, in particular crown ethers. Particularly suitable are for example tetra-hydrofurane or tetrahydrofurane derivatives with the molecular formula C₄OR¹R²R³R⁴R⁵R⁶R⁷R⁸, wherein R¹ to R⁸ are selected from the group —H and —CₙH₂ₙ₊₁ with n representing a positive integer from 1 to 12. As already described with respect to cyclo-alkanes, the physical properties of the cyclic ether can be influenced by proper selection of groups R, for example with respect to the number of carbon atoms n in such a side chain. It is advantageous to choose the number of carbon atoms n in such a way, that the ether derivative is still liquid at the operating temperature and that its viscosity is suitable for use in an immersion projection apparatus. In this context, it is particularly advantageous to choose n between 1 and 10, even more advantageous between 1 and 7 and extraordinary advantageous between 1 and 5.

Although one would expect the transmission for light with a wavelength below 250 nm to be poor in ethers because of the free electron pairs of the oxygen atom, it has surprisingly been found that cyclic ethers, besides having suitable refractive indices, generally also possess very good transmission properties. A crown ether that can be used is 15-crown-5-(1,4,7,10,13)-pentaoxacyclopentadecane.

As in the cyclic hydrocarbons, suitably high refractive indices are also found in the analogous alcohols such as cyclohexanol or methyl-cyclohexanol. In comparison, the refractive indices of the corresponding open-chain alcohols are significantly lower.

Outstanding transmission properties are also present in methanol, isopropanol, and acetonitrile.

The immersion liquids found by the inventors, in particular immersion liquids with refractive indices above 1.50 at wavelengths of less than 250 nm, and in particular less than 200 nm, open the possibility for a valuable additional design benefit. In addition to increasing the resolution, it is also possible to reduce the geometric aperture for immersion liquids with refractive indices above 1.50. It has proven particularly favorable for the production of structures with a minimum width R to use an immersion liquid with a refractive index n which is not merely sufficient to allow the resolution of such structures, i.e.,

$$n \geq \frac{{k}_{1} \cdot λ}{R \cdot sin {θ}_{0}} .$$

Instead, it has been shown that an optimal resolution is achieved by using a liquid with refractive index n that meets the condition

$$n \geq \frac{S \cdot {k}_{1} \cdot λ}{R \cdot sin {θ}_{0}} ,$$

wherein S=1.05, preferably S=1.10, and with special preference S=1.15. In the foregoing expressions, λ represents the vacuum value of the operating wavelength being used, and sin Θ₀ represents the numerical aperture of the immersion objective. The angle Θ₀ corresponds to one half of the image side aperture angle in the immersion liquid. The empirical process-dependent constant k₁ in this case has a value greater than 0.26.

Further aspects and embodiments of the invention will become apparent from the dependent claims and the following description which refers to the appended figures. All combinations of the features disclosed, whether explicitly recited in the claims or not, are within the scope of the invention.

The invention will be explained in more detail hereinafter with reference to the drawings, wherein

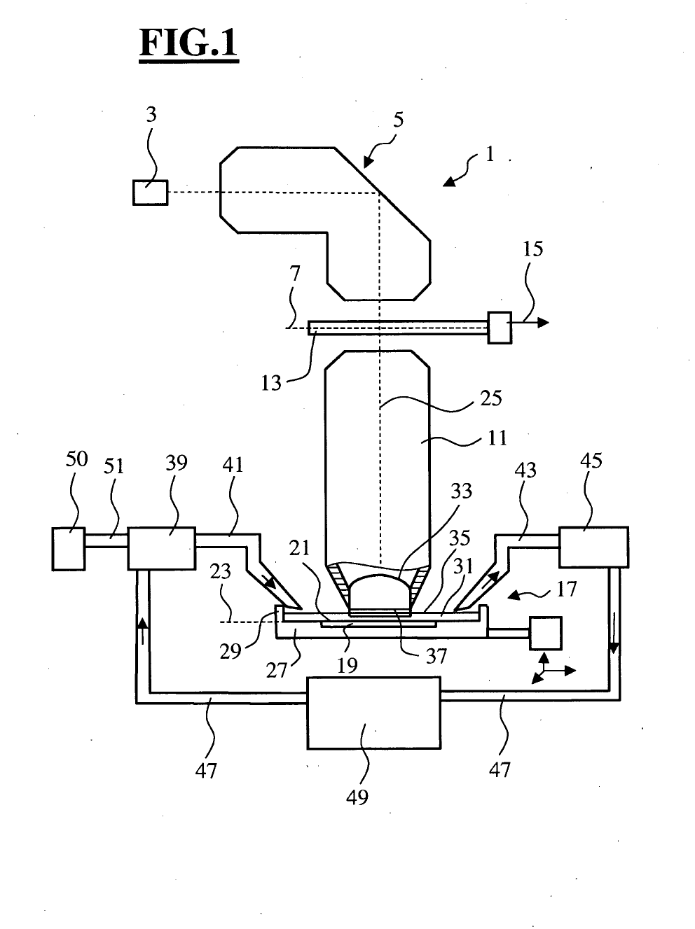

FIG. 1 represents a projection exposure apparatus with a projection objective, with an immersion liquid placed between a refractive optical element and the coated substrate; and

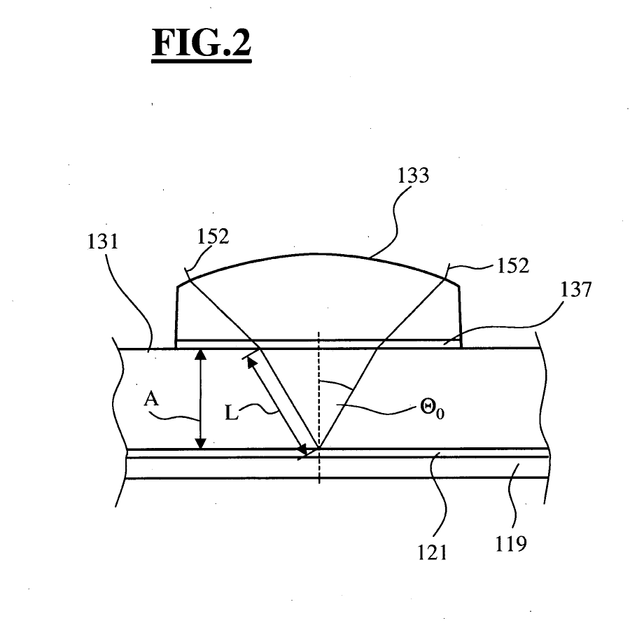

FIG. 2 represents an enlarged view of the light-sensitive substrate and the optical element closest to the substrate in a projection objective in accordance with the embodiment of FIG. 1.

FIG. 1 schematically illustrates a microlithography projection exposure apparatus 1 designed for the production of highly integrated semiconductor elements by means of immersion lithography. As a light source, the projection exposure apparatus 1 includes an excimer laser 3 with an operating wavelength of 248 nm. Alternatively, one could also use light sources with different operating wavelengths such as, e.g., 193 nm or 157 nm. An illumination system 5, arranged after the light source, produces at its exit plane or object plane 7 a large, sharply delimited illumination field of very homogeneous intensity, which is matched to the telecentricity requirements of the projection objective 11 that is arranged at a subsequent position in the apparatus. The illumination system 5 has devices for the control of the pupil illumination and for the selection of the illumination mode for setting a specified state of polarization of the illumination light. Proposed is in particular a device which polarizes the illumination light in such a way that the plane of oscillation of the electrical field vector runs parallel to the structures of the mask 13.

A reticle stage, i.e., a device for holding and moving a mask 13, is arranged in the light path after the illumination system, so that the mask 13 lies in the object plane 7 of the projection objective 11 and can be moved in a travel direction 15 in this plane to perform a scan.

Behind the object plane 7, which is also referred to as mask plane, the reduction objective 11 follows next in series, projecting a reduced-scale image of the mask onto a substrate 19, for example a silicon wafer, that is coated with a photo-sensitive resist 21. The substrate 19 is arranged so that the planar substrate surface carrying the resist 21 substantially coincides with the image plane 23 of the projection objective 11. The substrate is held by a device 17 which includes a drive mechanism to move the substrate 19 in synchronism with and anti-parallel to the mask 13. The device 17 also includes manipulators for the purpose of advancing the substrate 19 in the z-direction, i.e., parallel to the optical axis 25 of the projection objective 11, as well as in the x- and y-directions perpendicular to the optical axis. A tilting device with at least one tilt axis running perpendicular to the optical axis 25 is integrated in the device 17.

The device 17 for holding the substrate 19 (the wafer stage) is designed for use in immersion lithography applications. It includes a receiving device 27 which has a base with a flat recess to receive the substrate 19 and which is movable by a scanner drive mechanism. A border 29 around the perimeter forms a shallow liquid-tight receptacle that is open on top and serves to hold an immersion liquid 31. The height of the border is dimensioned so that when the immersion liquid 31 is in place, it can completely cover the substrate surface with the resist 21, and with the operating distance between the exit plane of the objective and the substrate surface correctly adjusted, the exit-end portion of the projection objective 11 can be submerged in the immersion liquid 31.

The projection objective 11 has an image-side numerical aperture NA of at least NA=0.6, but preferably more than 0.8, and with special preference more than 0.95. Thus, it is specifically adapted for use with highly refractive immersion liquids 31.

The last optical element of the projection objective 11, closest to the image plane 23, is a planar-convex lens 33 whose exit surface 35 is the last optical surface of the projection objective 11. When the projection exposure apparatus is in operation, the exit side of the last optical element is completely submerged in the immersion liquid 31 and is wetted by the latter. To make the last optical element more resistant against degradation due to attack by the immersion liquid, the exit surface 35 of the planar-convex lens 33 is coated with a protective layer system 37. The protective layer system 37 helps to prevent that the lens material, for example calcium fluoride or barium fluoride, which has a small degree of solubility in the immersion liquid, is attacked and gradually dissolved by the latter. In addition, through an appropriate choice of the coating material and layer thickness, the protective layer system 37 can be optimized in such a way that it works as an anti-reflex coating for the boundary surface between the optical system and the immersion liquid. The thickness of the protective layer system is optimized in regard to resolution properties and imaging aberrations induced by the resolution. Depending on the chemical properties of the immersion liquid, it is also possible to omit the protective layer system.

The immersion liquid is introduced by an inlet device 39 through an inlet conduit 41 into the liquid receptacle formed by the raised border 29 in the wafer stage 17. On an opposite side from the inlet of the liquid receptacle, the immersion liquid 31 is suctioned off through an outlet conduit 43 by means of drainage device 45. The drainage device 45 delivers the immersion liquid 31 to a regeneration circuit 47 which contains a regeneration device 49, for example a distillation apparatus or chromatography column. From the regeneration device 49, the purified immersion liquid 31 is returned to the inlet device 39. Alternatively, there can be a direct connection between the drainage device 45 and the inlet device 39, bypassing the regeneration circuit 47. This allows the immersion liquid 31 to be used repeatedly without the intervening purification step. The purity of the immersion liquid 31 can be monitored with the help of a measuring and control device that is not shown in the drawing, and when certain threshold values are exceeded, a purification cycle can be initiated. New immersion liquid is brought into the circuit from a supply reservoir 50 by way of supply conduits 51, because the regeneration of the immersion liquid 31, for example in a distillation apparatus, leads to losses in the quantity of liquid.

Individual immersion liquids that are particularly well suited for use in a projection exposure apparatus with an operating wavelength of 248 nm are summarized in Table I. Some of these substances are also suitable for an operating wavelength of 193 nm. The refractive indices n_{g} at 435.8 nm were determined in an Abbe refractometer with an HgCd spectral lamp. The refractive indices at 193.4 nm and 248 nm were determined with a laser light source by means of a 50° triangular cuvette according to the principle of minimal deviation.

All of the substances listed in Table I have a sufficiently high transmission for light of 248 nm wavelength. Cyclohexane has a refractive index of 1.4359 at a wavelength of 435.8 nm. Thus, in comparison to n-hexane (1.3834) a markedly higher refractive index value is obtained for the cyclic compound. At the wavelength of 193.4 nm, a refractive index as high as 1.565 was measured for cyclohexane. The profile of the transmission values shows that the absorption edge is close to the operating wavelength of 193 nm. By adapting the operating distance to the low transmission, one can however still achieve an acceptable amount of light. In this regard, it is conceivable to reduce the operating distance down to 100 μm.

A comparison between the refractive indices of cyclooctane and isooctane likewise confirms the general trend that the refractive index of the cyclic compound is markedly higher than for the analogous open-chain compound with the same number of carbon atoms. In this case, the respective refractive indices of the cyclic and noncyclic compound at a wavelength of 435.8 nm differ from each other by 0.0684. One can make the general statement that cyclic saturated hydrocarbons as a rule have higher refractive indices than their non-cyclic homologs. At a wavelength of 248 nm, isooctane already has a refractive index of 1.5251, i.e., clearly higher than quartz glass.

Even higher refractive indices are found in the poly-cyclic hydrocarbons decahydronaphthalene (also known by its trivial name decalin) and perhydrofluorene. The data listed in Table I were determined from a mixture of cis- and trans-decahydronaphthalene. A sufficiently high transmission at 248 nm is assured with both substances. After covering a distance of 10 mm, light of a wavelength of 250 nm still has 92% of its original intensity when traveling through a decahydronaphthalene sample, which corresponds to an extinction coefficient of 0.083 cm⁻¹. In perhydrofluorene, the extinction coefficient for light of 250 nm wavelength is 0.248 cm⁻¹, which corresponds to an attenuation of 22% after a travel distance of 10 mm. By improving the purification process for these liquids and through complete hydration, their transmission properties can be further improved. It is also possible to achieve a sufficient amount of available light by shortening the operating distance. In a first sample of decahydronaphthalene, a refractive index of 1.5434 was determined at a wavelength of 248 nm and a temperature of 21° C., and of 1.6380 at a wavelength of 193.4 nm and a temperature of 23° C. In a second sample, an even higher refractive index of 1.647 was found at a wavelength of 193.4 nm, and of 1.6401 in a third sample. For perhydrofluorene at the same conditions, a refractive index of 1.5771 was found at a wavelength of 248 nm, and even a value of 1.6862 at 193 nm. All of these values significantly exceed the refractive indices of quartz glass or CaF₂ at comparable wavelengths.

In measurements performed in mixtures of decalin of the cis- and trans-configuration, it was found that the refractive index will change depending on the ratio in which the two configurations are present in the mixture. Thus, different samples of decahydronaphthalene at 193.4 nm show significantly different refractive indices which cannot be traced to imprecision of the measuring process. Rather, the reason for these variations of the refractive index in different samples is that slightly different conditions in the production and purification of the decalin lead to different ratios of the two stereo-isomeric cis- and trans configurations in the mixture. In decahydronaphthalene, the cis-configuration has a higher refractive index than the trans-configuration. The higher the proportion of the cis-decalin in a mixture of isomers, the higher is the refractive index of the mixture. Accordingly, it is possible to set a specific index of refraction of the immersion liquid through an appropriate ratio of the two configurations in the mixture.

As a consequence of the principle that an increase in the number of rings of a polycyclic saturated hydrocarbon leads to an increase of the refractive index, further substances can be considered for immersion liquids with a high refractive index. For example, it is possible to produce further polycyclic saturated hydrocarbons besides decahydronaphthalene (from naphthalene) or perhydrofluorene (from fluorene) from known polynucleic polycyclic aromatic hydrocarbons by complete catalytic hydration, e.g., with Raney nickel. Some of them are summarized in Table II.

The complete catalytic hydration of larger polynucleic polycyclic aromatic hydrocarbons, for example pyrene or coronene, is likewise possible with a nickel catalyst. The method is described in the article “Über das Coronen” (About Coronene), Fischer-Tropsch Archive, TOM tape reel 1 (full documents), pocket 2168, C.I.O.S., target No. 30/4.03, Ludwigshafen-Oppau. The use of a nickel catalyst has a preferred tendency to produce low-melting isomers of the perhydrated compounds, which makes this process an advantageous choice for the production of immersion liquids. In the case of the complete hydration of pyrene, the main product coming out of the process with a nickel catalyst is a perhydropyrene isomer that is liquid at room temperature, while the hydration with tungsten sulfide as a catalyst produces a mixture of two perhydrated isomers that are in the solid phase at room temperature, having melting points of 67° C. and 104° C., respectively.

For light with a wavelength of 193 nm, the transmission of decalin in the sample under test with a length of 10 mm being traversed by the radiation fell to 6.3%, which corresponds to an extinction coefficient of 2.765 cm⁻¹. To make use of the high refractive index of decalin even at a wavelength of 193 nm, an appropriately configured projection exposure system can be designed for a operating distance of only 1 mm. As the transmission is a logarithmic function of the distance traversed by the radiation, this shortening of the operating distance has the result of increasing the transmission to 75%. Additionally, the transmission can be further improved through an optimized purification process.

Similar to the polycyclic hydrocarbons mentioned hereinabove, one can also expect high refractive indices for bridged polycyclic saturated hydrocarbons. Suitable polycyclic bridged hydrocarbons are summarily presented in Table III.

As can be further concluded from Table I, the refractive indices of methanol and isopropanol, 1.3356 and 1.3854, respectively, are entirely comparable to the refractive index of pure water. At the same time, a very good transmission at a wavelength of 248 nm is assured in both liquids.

In alcohols, too, one finds that the presence of a carbon ring leads to a higher refractive index. For example, cyclohexyl methanol at 435.8 nm has a refractive index of 1.474, which is even higher than for cyclohexane. Cyclohexanol at a wavelength of 248 nm has a refractive index of 1.5334, which is likewise significantly higher than the refractive index of quartz glass or CaF₂.

Relatively high refractive indices are also found in cyclic ether compounds. For example, the crown ether 15-crown-5-(1,4,7,10,13)-pentaoxacyclopentadecane has a refractive index of 1.4757 at a wavelength of 435.8 nm. Transmission measurements in a sample obtained from the supplier Aldrich, which had a purity of 98%, showed that the transmission at this wavelength was still about 88%. Samples of higher purity have a correspondingly higher transmission.

In projection exposure apparatus with an operating wavelength of 248 nm, the material used for the last optical element is often quartz glass. Some of the substances listed in Table I have a significantly higher refractive index at this wavelength than quartz glass whose refractive index is 1.4667 at a wavelength of 435.8 nm. In comparison, a typical resist for lithography applications at 248 nm normally has a refractive index of 1.7 to 1.8. If the refractive index of the immersion liquid is significantly higher than the refractive index of quartz glass but still less than the refractive index of the resist, then the space filled with immersion liquid can be used as an additional refractive positive lens in order to increase the resolution further. This is accomplished by selecting a meniscus shape for the last optical element of the projection objective, where the hollow surface of the meniscus is filled out by the immersion liquid.

Some of the substances listed in Table I have relatively low flash points. It is therefore of advantage to provide a protective gas atmosphere for the operation of the projection exposure apparatus to prevent the immersion liquid from igniting. This is realized through an appropriate enclosure of the interface area between the substrate and the objective, which can be flushed with a chemically inert gas, for example with a noble gas such as helium or argon, or with nitrogen.

FIG. 2 shows an enlarged detail of a projection exposure apparatus 1 of the kind shown in FIG. 1. In one embodiment, the planar-convex lens 133 is of quartz glass which at an operating wavelength of 193 nm has a refractive index of 1.5603. In this example, decahydronaphthalene with a refractive index of 1.6401 at 193 nm is used as an immersion liquid 131. As an alternative, one could also consider perhydrofluorene with a refractive index of 1.6862. The decahydronaphthalene used here is a mixture of isomers with a ratio of 1:1 between cis- and trans-decalin. The planar-convex lens 133 is coated with a protective layer system 137. This protective layer system consists of an anti-reflection layer system and may include a further layer of quartz to protect the anti-reflection layer system from being chemically attacked by the immersion liquid.

As the aperture rays 152 enter from the planar-convex lens into the optically denser immersion liquid 131, they are subject to refraction. Accordingly, they will meet the substrate 119 which is coated with a resist 121 at an angle of incidence Θ₀, corresponding to one half of the aperture angle in the immersion liquid. Respectively, the numerical aperture of this immersion objective is sin Θ₀.

The distance A between the planar-convex lens 133 and the resist-coated substrate 119 is adjusted so that at least 70% of the incoming radiation intensity reaches the substrate 119 after traveling a path length L through the immersion liquid 131.

TABLE 7

| | | Refract Index | | | | |
|---|---|---|---|---|---|---|
| | | n_{g} (435.8 nm) | | | | |
| | | at 20° C. | | | | |
| | | n₂₄₈ (248 nm) | | | | |
| | | at 21° C. | | | | |
| | Structural | n₁₉₃ (193.4 nm) | Transmission with | Boiling | Flush | |
| Substance | Formula | at 23° C. | 10 mm sample length | point T [symbol] | point T [symbol] | Density |
| Cyclohexane | 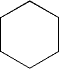 C₆H₁₂ | n_{g} = 1.4359 n₁₉₃ = 1.565 | 600 − 280 nm: ≧99.8% 260 nm: 98.8% 250 nm: 97.3% 240 nm: 91.8% 230 nm: 71.3% 220 nm: 43.8% 210 nm: 13.3% 200 nm: 3.6% | 81° C. | −18° C. | 0.78 g/cm³ |
| n-Hexane | 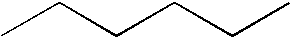 C₆H₁₄ | n_{g} = 1.3834 | 600 − 250 nm: ≧99.8% 240 nm: 98.4% 230 nm: 93.3% 220 nm: 86.3% 210 nm: 66.7% 200 nm: 30.0% 195 nm: 16.0% | 69° C. | −22° C. | 0.66 g/cm³ |
| Cyclooctane | 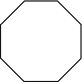 C₈H₁₆ | n_{g} = 1.4688 n₂₄₈ = 1.5251 | 600 − 310 nm: ≧99.8% 300 nm: 99.1% 280 nm: 96.2% 260 nm: 70.0% 250 nm: 71.9% 240 nm: 64.5% 230 nm: 37.6% | 152° C. | 30° C. | 0.834 g/cm³ |
| Isooctane | 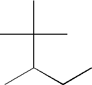 C₈H₁₈ | n_{g} = 1.4004 | 600 − 280 nm: ≧99.8% 260 nm: 99.4% 250 nm: 98.4% 240 nm: 96.6% 230 nm: 91.0% 220 nm: 78.5% 210 nm: 49.2% 200 nm: 18.0% | 99° C. | −12° C. | 0.692 g/cm³ |
| Decahydro- naphthalene (cis/trans mixture) | 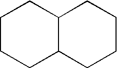 C₁₀H₁₈ | n_{g} = 1.4847 Sample 1: n₂₄₈ = 1.5434 n₁₉₃ = 1.6380 Sample 2: n₁₉₃ = 1.647 Sample 3: n₁₉₃ = 1.6401 | 600 − 300 nm: ≧99.8% 300 nm: 99.8% 260 nm: 95.9% 250 nm: 92.0% 240 nm: 79.4% 230 nm: 56.0% 220 nm: 31.5% 210 nm: 18.2% 200 nm: 6.3% | ca. 190° C. | 58° C. | 0.88 g/cm³ |
| Perhydro- fluorene | 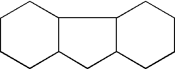 C₁₃H₂₂ | n_{g} = 1.5142 n₂₄₈ = 1.5771 n₁₉₃ = 1.6862 | 250 nm: 78% | 253° C. | 64° C. | 0.92 g/cm³ |
| Cyclo- hexanol | 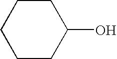 C₆H₁₁OH | n₂₄₈ = 1.5334 | 250 nm: 15.4% | n/a | n/a | n/a |
| Cyclo- hexyl- methanol | 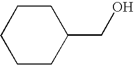 C₇H₁₃OH | n_{g} = 1.4747 | 250 nm: 23% | 181° C. | 71° C. | 0.93 g/cm³ |
| Methanol | CH₃OH | n_{g} = 1.3356 | 600 − 300 nm: ≧99.8% 280 nm: 96.2% 260 nm: 96.4% 250 nm: 94.6% 240 nm: 88.1% 230 nm: 69.2% 220 nm: 52.7% 210 nm: 28.5% 205 nm: 5.7% | 64.5° C. | 11° C. | 0.79 g/cm³ |
| Isopropanol | 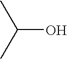 C₃H₇OH | n_{g} = 1.3854 | 600 − 300 nm: ≧99.8% 280 nm: 96.2% 260 nm: 96.4% 250 nm: 94.6% 240 nm: 88.1% 230 nm: 69.3% 220 nm: 52.7% 210 nm: 28.5% 200 nm: 5.7% | n/a | n/a | n/a |
| Acetonitrile | CH₃CN | n/a n_{g} = 1.3452 | 250 nm: 90.4% | n/a | n/a | n/a |

[symbol]

indicates data missing or illegible when filed

TABLE II

| | | Obtained by | |
|---|---|---|---|
| | | complete hydration | |
| | Structural formula of | from the base | Structural formula of |
| Immersion liquid | immersion liquid | compound | base compound |
| Perhydroanthrazene (Tetradekahydro- anthrazene | 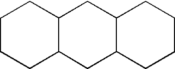 C₁₄H₂₄ | Anthrazene | 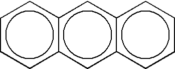 C₁₄H₁₀ |
| Perhydrophenanthrene (Tetradekahydro- phenanthrene) | 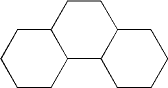 C₁₄H₂₄ | Phenanthrene | 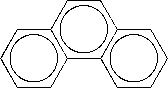 C₁₄H₁₀ |
| Perhydrochrysene (Oktadekahydro- chrysene) | 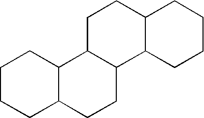 C₁₈H₃₀ | Chrysene | 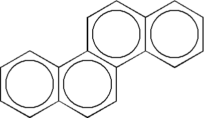 C₁₈ H₁₂ |
| Perhydropyrene | 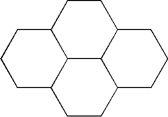 C₁₆H₂₆ | Pyrene | 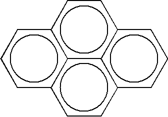 C₁₆H₁₀ |
| Perhydroindene | 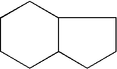 C₉H₁₆ | Indene | 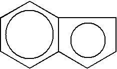 C₉H₇ |
| Perhydropentalene | 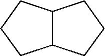 C₈H₁₄ | Pentalene | 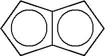 C₈H₆ |
| Perhydroazulene | 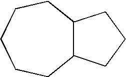 C₁₀H₁₈ | Azulene | 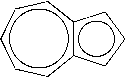 C₁₀H₈ |
| Perhydroheptalene | 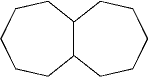 C₁₂H₂₂ | Heptalene | 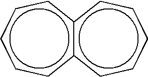 C₁₂H₁₀ |
| Perhydrobiphenylene | 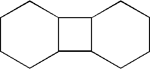 C₁₂H₂₀ | Biphenylene | 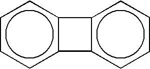 C₁₂H₈ |
| Perhydroindazene | 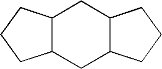 C₁₂H₂₀ | Indazene | 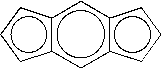 C₁₂H₈ |
| Perhydroazenaphthylene | 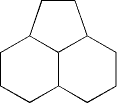 C₁₂H₂₀ | Azenaphthylene | 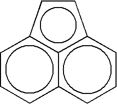 C₁₇H₈ |
| Perhydrophenalene | 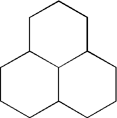 C₁₃H₂₄ | Phenalene | 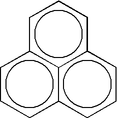 C₁₃H₁₂ |
| Perhydronaphthazene | 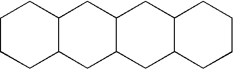 C₁₈H₃₀ | Naphthazene | 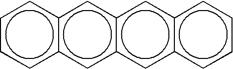 C₁₈H₁₂ |
| Perhydrofluoranthene | 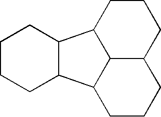 C₁₆H₂₆ | Fluoranthene | 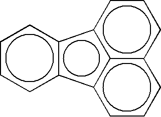 C₁₆H₁₀ |
| Perhydrobenzopyrene | 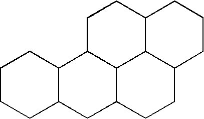 C₂₀H₃₂ | Benzopyrene | 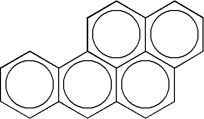 C₂₀H₁₂ |
| Perhydrobenzo-(k)- fluoranthene | 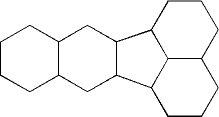 C₂₀H₃₂ | Benzo-(k)- fluoranthene | 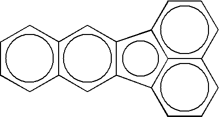 C₂₀H₁₂ |
| Perhydroindenopyrene | 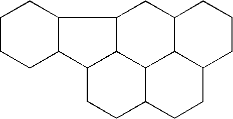 C₂₂H₃₄ | Indenopyrene | 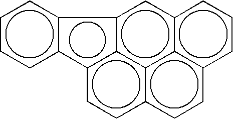 C₂₂H₁₂ |
| Perhydrotetraphenylene | 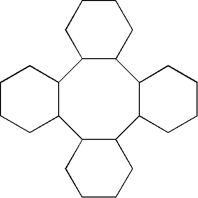 C₂₄H₄₀ | Tetraphenylene | 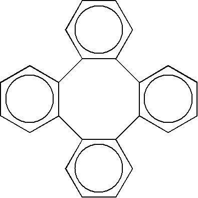 C₂₄H₁₆ |

TABLE III

| Immersion Liquid | Formula | Structure |
|---|---|---|
| Norbornane | C₇H₁₂ | 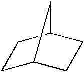 |
| Adamantane | C₁₀H₁₆ | 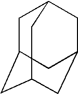 |
| Tricyclodecane | C₁₀H₁₆ | 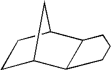 |
| Bicyclo[3.3.2]decane | C₁₀H₁₈ | 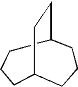 |

1-28. (canceled)

29. Projection exposure apparatus with
a projection objective that projects a structure onto a substrate,
wherein an immersion liquid is arranged between a refractive optical element of the projection objective and the substrate,
wherein the immersion liquid is a saturated cyclic or polycyclic hydrocarbon.

30. Projection exposure apparatus according to claim 29, wherein the immersion liquid at an illumination wavelength of 248 nm has an extinction coefficient smaller than 1.19 cm⁻¹.

31. Projection exposure apparatus according to claim 29, wherein the immersion liquid at an illumination wavelength of 193 nm has an extinction coefficient smaller than 35.6 cm⁻¹.

32. Projection exposure apparatus according to claim 29, wherein the distance between the optical element and the coated substrate is adjusted so that the transmission through the immersion liquid is more than 70%.

33. Projection exposure apparatus according to claim 29, wherein the projection exposure apparatus comprises a regeneration circuit for the immersion liquid.

34. Projection exposure apparatus according to claim 33, wherein the regeneration circuit comprises a distillation apparatus.

35. Projection exposure apparatus according to claim 29, wherein the immersion liquid is a cyclo-alkane or a cyclo-alkane derivative.

36. Projection exposure apparatus according to claim 35, wherein the immersion liquid is cyclohexane.

37. Projection exposure apparatus according to claim 35, wherein the immersion liquid is a cyclohexane derivative with the molecular formula C₆R¹R²R³R⁴R⁵R⁶R⁷R⁸R⁹R¹⁰R¹¹R¹², wherein R¹ to R¹² are selected, respectively, from the group that consists of —H and —CₙH₂ₙ₊₁, wherein n represents a positive integer between 1 and 12.

38. Projection exposure apparatus according to claim 35, wherein the immersion liquid is cyclooctane.

39. Projection exposure apparatus according to claim 35, wherein the immersion liquid is a cyclooctane derivative with the molecular formula C₈R¹R²R³R⁴R⁵R⁶R⁷R⁸R⁹R¹⁰R¹¹R¹²R¹³R¹⁴R¹⁵R¹⁶, wherein R¹ to R¹⁶ are selected, respectively, from the group that consists of —H and —CₙH₂ₙ₊₁, where n represents a positive integer between 1 and 12.

40. Projection exposure apparatus according to claim 35, wherein the immersion liquid has the molecular formula CₖH₂ₖ, where k represents a positive integer between 7 and 12.

41. Projection exposure apparatus according to claim 35, wherein the immersion liquid is selected from the group that consists of cyclopentane, cycloheptane, cyclononane, cyclodecane, cycloundecane and cyclododecane.

42. Projection exposure apparatus according to claim 35, wherein the immersion liquid is a derivative of a cycloalkane with the molecular formula CₖR¹ . . . R^{2k}, wherein R¹ to R^{2k} are selected, respectively, from the group that consists of —H and CₙH₂ₙ₊₁, wherein k is a positive integer between 7 and 12 and n is a positive integer between 1 and 12.

43. Projection exposure apparatus according to claim 42, wherein n is a positive integer between 1 and 5.

44. Projection exposure apparatus according to claim 35, wherein the immersion liquid is a derivative of a cyclo-alkane selected from the group consisting of cyclopentane, cycloheptane, cyclononane, cyclodecane, cycloundecane or cyclododecane, comprising a side chain R, wherein R is selected from the group that consists of —H and —CₙH₂ₙ₊₁.

45. Projection exposure apparatus according to claim 29, wherein the immersion liquid is selected from the group that consists of decahydronaphthalene, perhydrofluorene, perhydroindene, perhydrophenanthrene, perhydrobenzopyrene, perhydroanthrazene, perhydrofluorantene, perhydroindenopyrene, perhydrobenzofluoranthene, perhydrochrysene, perhydrotetraphenylene, perhydropentalene, perhydroazulene, perhydroheptalene, perhydrobiphenylene, perhydroindazene, perhydroacenaphthylene, perhydrophenalene, perhydropyrene, perhydronaphthazene, and perhydrocoronene.

46. Projection exposure apparatus according to claim 29, wherein the immersion liquid is a derivative of one of the substances selected from the group that consists of decahydronaphthalene, perhydrofluorene, perhydroindene, perhydrophenanthrene, perhydrobenzopyrene, perhydroanthrazene, perhydrofluoranthene, perhydroindenopyrene, perhydrobenzofluoranthene, perhydrochrysene, perhydrotetraphenylene, perhydropentalene, perhydroazulene, perhydroheptalene, perhydrobiphenylene, perhydroindazene, perhydroacenaphthylene, perhydrophenalene, perhydropyrene, perhydronaphthazene, and perhydrocoronene, comprising a side chain R, wherein R is selected from the group that consists of —H and —CₙH₂ₙ₊₁.

47. Projection exposure apparatus according to claim 29, wherein the immersion liquid is a bridged polycyclic hydrocarbon.

48. Projection exposure apparatus according to claim 47 wherein the immersion liquid is selected from the group that consists of norbornane, adamantane, tricyclodecane, or bicyclo [3.3.2]-decane.

49-86. (canceled)
